(19) United States
(12) Patent Application Publication
(10) Pub. No.: US 2013/0198544 A1
(43) Pub. Date: Aug. 1, 2013

(54) POWER CONTROL SYSTEM AND RELATED METHOD OF OPERATION

(71) Applicants: JAE-HYEON JU, SEOUL (KR); HYO-JIN JEONG, SEONGNAM-SI (KR)

(72) Inventors: JAE-HYEON JU, SEOUL (KR); HYO-JIN JEONG, SEONGNAM-SI (KR)

(73) Assignee: SAMSUNG ELECTRONICS CO., LTD., SUWON-SI (KR)

(21) Appl. No.: 13/597,467

(22) Filed: Aug. 29, 2012

(30) Foreign Application Priority Data
Jan. 30, 2012 (KR) 10-2012-0009071

(51) Int. Cl. G06F 1/32

(52) U.S. Cl. 713/323; 713/320

(57) ABSTRACT

An electronic system comprises a storage device and a host device each having a high power mode and a low power mode. The respective power modes of the storage device and the host device are changed in coordination with each other.

### CROSS-REFERENCE TO RELATED APPLICATIONS

This application claims priority under 35 U.S.C. §119 to Korean Patent Application No. 10-2012-0009071 filed on Jan. 30, 2012, the disclosure of which is hereby incorporated by reference.

### BACKGROUND OF THE INVENTION

The inventive concept relates generally to electronic data processing and data storage technologies. More particularly, the inventive concept relates to power control systems for electronic data processing and data storage devices.

There is a general trend to increase the integration density of electronic data processing and data storage devices. Such increases tend to improve the data processing and/or storage capacity of these devices, as well as their operating speed. At the same time, however, increasing the integration density also tends to increase power consumption.

In general, the rate of increase in integration density has been greater than the rate of improvements in battery technology. Accordingly, many electronic devices suffer reduced battery life as a consequence of increased integration density. In addition, increased power consumption can present other problems such as increasing the overall cost of operating electronic devices, and increasing the amount of heat generated by the devices.

In view of these and other shortcomings of conventional technologies, there is a general need for improved approaches to managing power consumption in electronic devices.

### SUMMARY OF THE INVENTION

In one embodiment of the inventive concept, a system comprises a host device that has a first power mode in which power is consumed at a first rate and a second power mode in which power is consumed at a second rate lower than the first power rate, a storage device that has a third power mode in which power is consumed at a third rate and a second power mode in which power is consumed at a fourth rate lower than the third rate, and a mode selector that changes host device from the first power mode to the second power mode as a consequence of the host device receiving power from an internal voltage source, and changes the storage device from the third power mode to the fourth power mode as a consequence of the host device changing to the second power mode.

In another embodiment of the inventive concept, a system comprises first and second storage devices, a first host device comprising a first computing unit that interfaces with the first storage device, and a second host device comprising a second computing unit that interfaces with the second storage device. Each of the first and second storage devices has a first power mode in which power is consumed at a first rate and a second power mode in which power is consumed at a second rate smaller than the first rate. Each of the first and second computing units comprises a first core that processes information at a first processing rate and a second core that processes information at a second processing rate, wherein the second processing rate is smaller than the first processing rate. When system power for driving the second host device is supplied from a battery installed in the second host device, the first core of the first host device is active, the first core of the second host device is idle, the second core of the second host is active, the first storage device operates in the first power mode, and the second storage device operates in the second power mode.

In another embodiment of the inventive concept, a method is provided for controlling power consumption in an electronic system comprising a storage device and a host device. The method comprises changing respective power modes of the storage device and the host device between high and low levels in coordination with each other.

These and other embodiments of the inventive concept can potentially reduce power consumption of electronic devices, which can improve battery life and operating cost.

### BRIEF DESCRIPTION OF THE DRAWINGS

The drawings illustrate selected embodiments of the inventive concept. In the drawings, like reference numbers indicate like features.

FIG. 1 is a block diagram of a power control system according to an embodiment of the inventive concept.

FIG. 2 is a block diagram of a power control system according to another embodiment of the inventive concept.

FIG. 3 is a block diagram of a power control system according to another embodiment of the inventive concept.

FIG. 4 is a block diagram of a power control system according to another embodiment of the inventive concept.

FIG. 5 is a block diagram of a power control system according to another embodiment of the inventive concept.

FIG. 6 is a block diagram of a power control system according to another embodiment of the inventive concept.

FIG. 7 is a block diagram of a power control system according to another embodiment of the inventive concept.

### DETAILED DESCRIPTION

Embodiments of the inventive concept are described below with reference to the accompanying drawings. These embodiments are presented as teaching examples and should not be construed to limit the scope of the inventive concept.

In the description that follows, the terms “a”, “an”, “the” and similar referents shall be construed to encompass both the singular and the plural forms unless clearly indicated to the contrary. Terms such as “comprising,” “having,” “including,” and “containing” are to be construed as open-ended terms unless otherwise noted.

Unless defined otherwise, all technical and scientific terms used herein have the same meaning as commonly understood by one of ordinary skill in the art. The use of any and all examples or example terms is intended merely to illuminate the inventive concept and is not to limit the scope of the inventive concept unless otherwise indicated. Unless clearly indicated to the contrary, terms defined in generally used dictionaries shall not be interpreted in an overly formal sense.

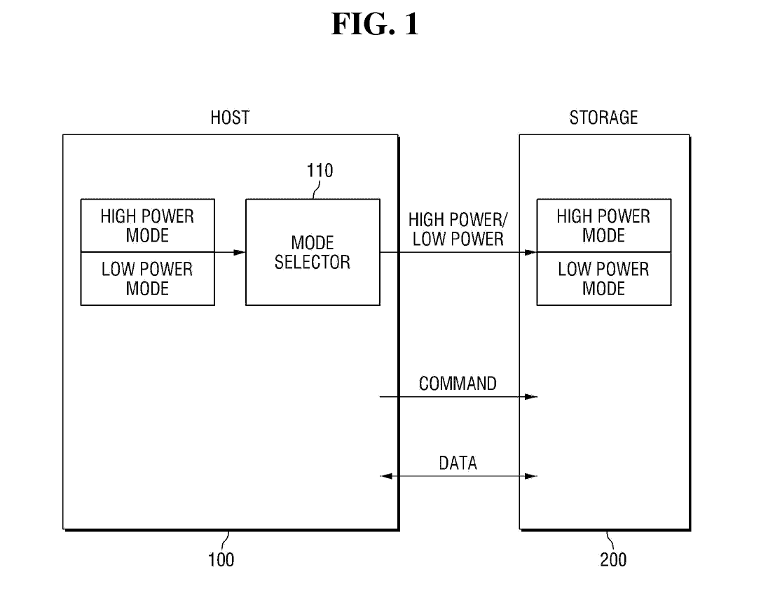

FIG. 1 is a block diagram of a power control system according to an embodiment of the inventive concept.

Referring to FIG. 1, the power control system comprises a host device 100, a mode selector 110, and a storage device 200. Host device 100 operates alternatively in a high power mode in which power is consumed at a first rate and a low power mode in which power is consumed at a second rate lower than the first rate. Host device 100 may be, for example, a mobile phone, a two-way radio communication system, a one-way pager, a two-way pager, a personal communication system, a portable computer, a personal digital assistant (PDA), an audio and/or video player, a digital and/or video camera, a navigation system, or a global positioning system (GPS).

Like host device 100, storage device 200 operates alternatively in a high power mode in which power is consumed at a third rate and a low power mode in which power is consumed at a fourth rate smaller than the third rate. Storage device 200 may be, for example, a nonvolatile memory device, such as a semiconductor disk device (SSD), or a hard disk device.

Mode selector 110 sets a power mode of storage device 200 according to a power mode of host device 100. For example, mode selector 110 may set the operating power mode of storage device 200 to be the same as the power mode of host device 100. Accordingly, when host device 100 operates in the high power mode, mode selector 110 sets the power mode of storage device 200 to the high power mode, and when host device 100 operates in the low power mode, mode selector 110 sets the power mode of storage device 200 to the low power mode.

When storage device 200 operates in the low power mode, the amount of power consumed per unit of time by storage device 200 is reduced as described above. In addition, the operating speed of storage device 200 may be reduced compared when storage device 200 operates in the high power mode. Accordingly, the amount of data input to or output from storage device 200 in response to a command from host device 100 may be greater when storage device 200 operates in the high power mode than in the low power mode.

Mode selector 110 may be implemented as hardware, software, or any other form allowing it to set the power mode of storage device 200 according to the power mode of host device 100. Mode selector 110 is typically incorporated in host device 100 as shown in FIG. 1. For example, it may form part of a host controller (not shown) of host device 100. However, the inventive concept is not limited to the configuration shown in FIG. 1, and the implementation of mode selector 110 can be modified in alternative embodiments. For example, mode selector 110 may be an independent entity which is separate from host device 100 and storage device 200, or mode selector 110 may be implemented in a storage device controller (not shown) of storage device 200.

When host device 100 operates in the low power mode, the amount of computation performed by host device 100 per unit of time is reduced. Therefore, even if the amount of data provided per unit of time to host device 100 by storage device 200 is reduced, host device 100 may operate without impediment. Therefore, when host device 100 operates in the low power mode, if storage device 200 is also made to operate in the low power mode, the amount of power consumed by storage device 200 can be reduced without degrading the performance of an electronic device incorporating host device 100 and storage device 200.

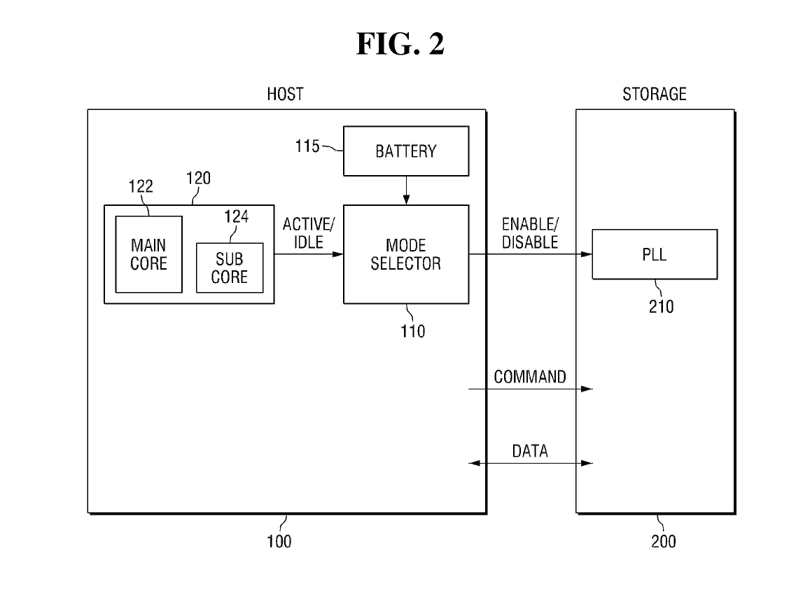

FIG. 2 is a block diagram of a power control system according to another embodiment of the inventive concept. The embodiment shown in FIG. 2 is a variation of the embodiment shown in FIG. 1.

Referring to FIG. 2, host device 100 comprises a computing unit 120 configured to perform computations at different rates. In particular, computing unit 120 comprises a main core 122 that performs computations at a higher rate and a sub core 124 that performs computations at a lower rate. Because main core 122 performs computing at a higher rate than sub core 124, it consumes more power than sub core 124. Consequently, when main core 122 is active, host device 100 operates in the high power mode. Because sub core 124 performs computing at a lower rate than main core 122, it consumes less power than main core 122. Accordingly, main core 122 is idle while sub core 124 is active so that host device 100 may operate in the low power mode.

A potential situation when main core 122 is idle while sub core 124 is active is when host device 100 merely plays music stored in storage device 200. In this case, mode selector 110 changes the power mode of storage device 200 to the low power mode in order to reduce the power consumption of an electronic device.

Changing the power mode of storage device 200 to the low power mode can be achieved by changing various settings of storage device 200. For example, mode selector 110 may disable a phase locked loop 210 (PLL) in storage device 200. When PLL 210 of storage device 200 is disabled, the amount of power consumed by PLL 210, which consumes a large portion of the power consumption of storage device 200, is reduced. Accordingly, storage device 200 may operate in the low power mode, and a bandwidth of storage device 200 is reduced, thereby reducing the operating speed of storage device 200.

Host device 100 and storage device 200 may serially interface with each other through a certain interface, such that mode selector 110 can enable or disable PLL 210 in storage device 200. Specifically, host device 100 and storage device 200 may interface with each other through a protocol-based serial interface comprising a bit indicating the power mode (high power mode (PLL enable), low power mode (PLL disable)) of storage device 200.

The following Table 1 illustrates various operation states of the power control system of FIG. 2 as described above.

TABLE 1

| Feature | Low Power Mode | High Power Mode |
|---|---|---|
| MAIN CORE | IDLE | ACTIVE |
| SUB CORE | ACTIVE | ACTIVE/IDLE |
| MODE SELECTOR | PLL DISABLE | PLL ENABLE |

As indicated by Table 1, while main core 122 of host device 100 is active, mode selector 110 enables PLL 210 of storage device 200 such that storage device 200 operates in the high power mode. When main core 122 of host device 100 is idle while sub core 124 is active, mode selector 110 disables PLL 210 of storage device 200 such that storage device 200 operates in the low power mode.

Host device 100 may be operated by system power, which can be supplied from an external or internal voltage source. When the system power is supplied to host device 100 from the internal voltage source, it may originate from a battery 115 installed in host device 100, for example. When the system power is supplied to host device 100 from the external voltage source, host 100 may be electrically connected to the external voltage source to charge battery 115 installed in host device 100.

When host device 100 receives the system power from the internal voltage source, mode selector 110 may set the power mode of storage device 200 to the low power mode (e.g., PLL disable) due to a limited lifetime of battery 115.

The variable operation of the power control system based on the use of an internal or external voltage source is illustrated by the following Table 2.

TABLE 2

| Feature | Low Power Mode | High Power Mode |
|---|---|---|
| MAIN CORE | IDLE | ACTIVE |
| SUB CORE | ACTIVE | ACTIVE/IDLE |
| VOLTAGE SOURCE | INTERNAL | INTERNAL/EXTERNAL |
| MODE SELECTOR | PLL DISABLE | PLL ENABLE |

(A/B indicates that both A and B are possible)

Although host device 100 and storage device 200 are separated from each other in the embodiment of FIG. 2, storage device 200 can be embedded in host device 100 in certain alternative embodiments. In other words, host device 100 and storage device 200 can be physically integrated into one system in some embodiments of the inventive concept.

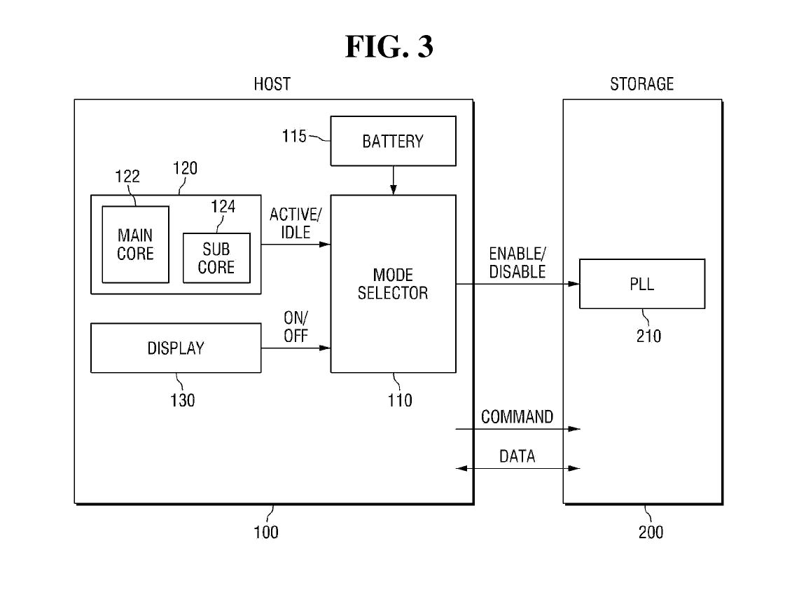

FIG. 3 is a block diagram of a power control system according to another embodiment of the inventive concept. The power control system of FIG. 3 is another variation of the power control system of FIG. 1. For the sake of brevity, a repetitive description of features substantially the same as those explained in relation to other embodiments will be omitted.

Referring to FIG. 3, host device 100 further comprises a display unit 130 that displays images. When display unit 130 is on, it may take up a large portion of the total power consumption of host device 100. Therefore, when display unit 130 is off, the power consumption of host device 100 is significantly reduced. Accordingly, host device 100 can operate in a low power mode when display unit 130 is off. The low power mode can be accomplished, for instance, by operating mode selector 110 to disable PLL 210 within storage device 200.

An example situation when display unit 130 is off while a main core 122 is idle and a sub core 124 is active may be when host device 100 merely plays music contents stored in storage device 200.

The following Table 3 illustrates example states of features in the power control system in the low power and high power modes as described above in relation to FIG. 3.

TABLE 3

| Feature | Low Power Mode | High Power Mode |
|---|---|---|
| MAIN CORE | IDLE | ACTIVE |
| SUB CORE | ACTIVE | ACTIVE/IDLE |
| VOLTAGE SOURCE | INTERNAL | INTERNAL/EXTERNAL |
| DISPLAY | OFF | ON/OFF |
| MODE SELECTOR | PLL DISABLE | PLL ENABLE |

(A/B indicates that both A and B are possible)

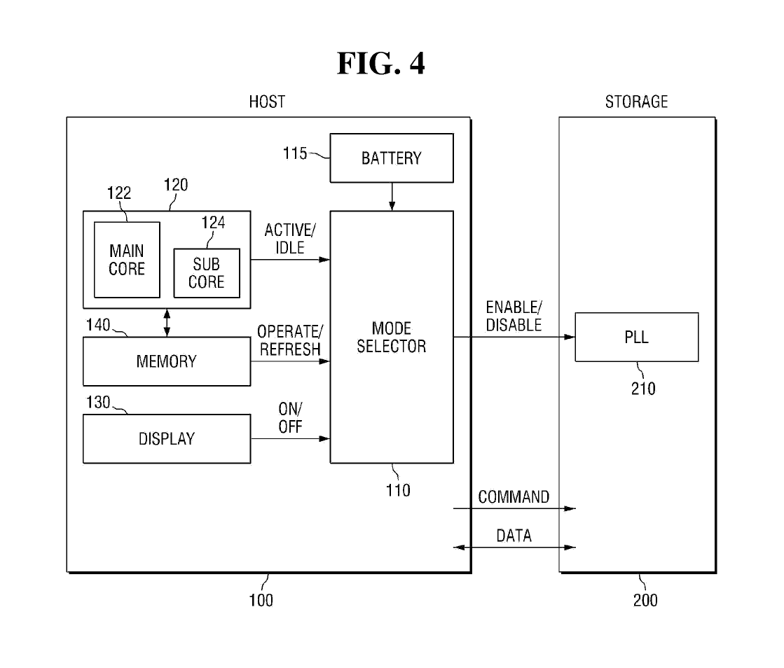

FIG. 4 is a block diagram of a power control system according to another embodiment of the inventive concept. The power control system of FIG. 4 is yet another variation of the power control system of FIG. 1. For the sake of brevity, a repetitive description of features substantially the same as those explained in relation to other embodiments will be omitted.

Referring to FIG. 4, host device 100 further comprises a memory unit 140 used in the computations of computing unit 120. In some embodiments, memory unit 140 comprises a volatile memory. For example, memory unit 140 may comprise at least one dynamic random access memory (DRAM).

When main core 122 of host device 100 is active, that is, when host device 100 operates in the high power mode, memory unit 140 may operate in a mode allowing data input and output. On the other hand, when main core 122 of host device 100 is idle and host device 100 operates in the low power mode, memory unit 140 may operate in a refresh mode when stored data is maintained without the input or output of data. Accordingly, when memory unit 140 is in the refresh mode, mode selector 110 may disable PLL 210 of storage device 200 such that storage device 200 operates in the low power mode.

The following Table 4 illustrates the operation of mode selector 110 and other features of the power control system as described in relation to FIG. 4.

TABLE 4

| Feature | Low Power Mode | High Power Mode |
|---|---|---|
| MAIN CORE | IDLE | ACTIVE |
| SUB CORE | ACTIVE | ACTIVE/IDLE |
| VOLTAGE SOURCE | INTERNAL | INTERNAL/EXTERNAL |
| DISPLAY | OFF | ON/OFF |
| MEMORY | REFRESH | OPERATE/REFRESH |
| MODE SELECTOR | PLL DISABLE | PLL ENABLE |

(A/B indicates that both A and B are possible)

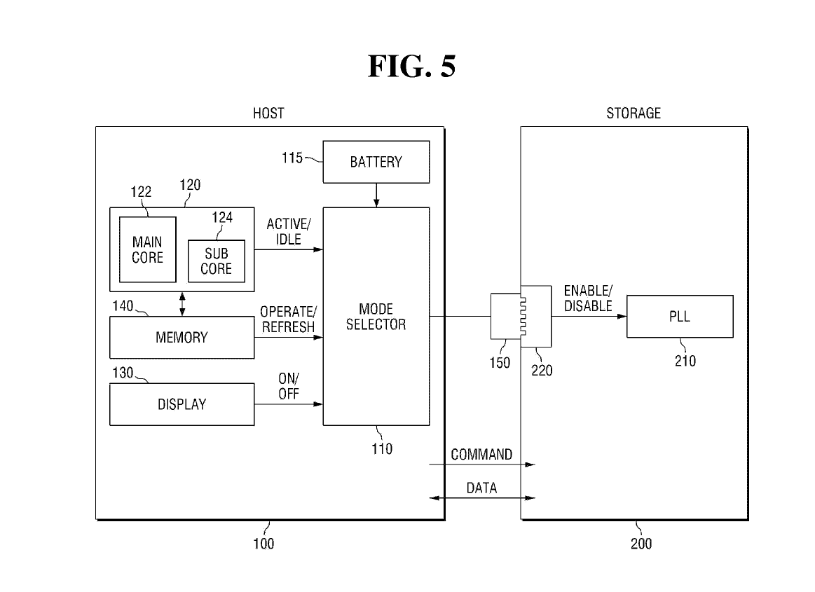

FIG. 5 is a block diagram of a power control system according to yet another embodiment of the inventive concept. The power control system of FIG. 5 is yet another variation of the power control system of FIG. 1. For the sake of brevity, a repetitive description of features substantially the same as those explained in relation to other embodiments will be omitted.

Referring to FIG. 5, host device 100 further comprises a first socket 150 that serially interfaces with host device 100. In addition, storage device 200 further comprises a second socket 220 that can be coupled to first socket 150. When second socket 220 of storage device 200 is coupled to first socket 150 of host device 100, host device 100 and storage device 200 can serially interface with each other.

In other words, in the embodiment of FIG. 5, storage device 200 is not embedded in host device 100 but can be connected to or disconnected from host device 100. Storage device 100 may be, but is not limited to a secure digital (SD) card. The operation of mode selector 110 is the same as in other embodiments, and thus a repetitive description thereof will be omitted.

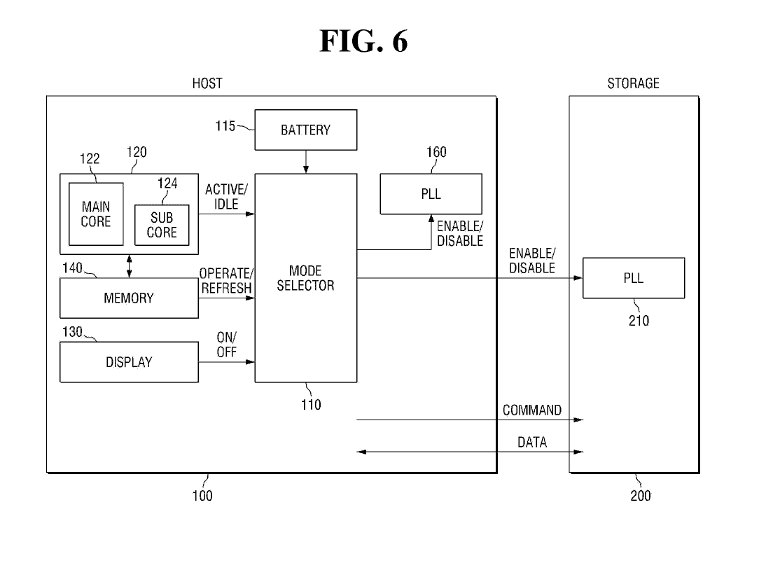

FIG. 6 is a block diagram of a power control system according to yet another embodiment of the inventive concept. The power control system of FIG. 6 is yet another variation of the power control system of FIG. 1. For the sake of brevity, a repetitive description of features substantially the same as those explained in relation to other embodiments will be omitted.

Referring to FIG. 6, host device 100 further comprises a PLL 160 separate from a PLL 210 in storage device 200. Mode selector 110 enables or disables both PLL 160 and PLL 210 under conditions when PLL 210 is enabled or disabled as described above.

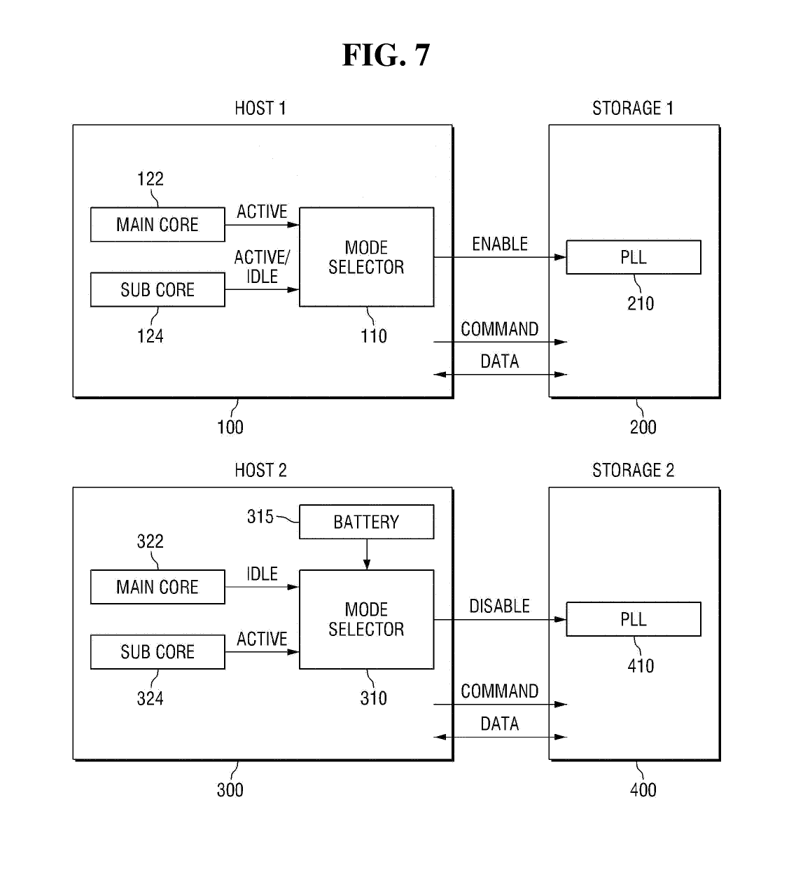

FIG. 7 is a detailed block diagram of a power control system according to another embodiment of the inventive concept.

Referring to FIG. 7, the power control system comprises first and second host devices 100 and 300 which are separate from each other and first and second storage devices 200 and 400 which are separate from each other. As shown in FIG. 7, first host device 100 interfaces with first storage device 200, and second host device 300 interfaces with second storage device 400.

When main core 122 is active, first host device 100 operates in the high power mode. Therefore, a first mode selector 110 enables a PLL 210 of first storage device 200 such that first storage device 200 operates in the high power mode.

Second host device 300 receives system power from a battery 315 installed therein. When a main core 322 of second host device 300 is idle while a sub core 324 is active, second host device 300 operates in the low power mode. Therefore, a second mode selector 310 disables a PLL 410 of second storage device 400 such that second storage device 400 operates in the low power mode.

In FIG. 7, state differences of main cores 122 and 322 and sub cores 124 and 324 of first host device 100 and second host device 300 are illustrated. However, the inventive concept is not limited to the illustrated features. For example, the power mode of first storage device 200 and the power mode of second storage device 400 can also be changed according to the states of a display unit 130 (see FIG. 4) and a memory unit 140 (see FIG. 4) which can additionally be included in first host device 100 and second host device 300.

As indicated by the foregoing, a power control system according to certain embodiments of the inventive concept can change a power mode of a storage device in response to a change in a power mode of a host device. This can reduce the amount of power required to drive an electronic device comprising the host device and the storage device.

The foregoing is illustrative of embodiments and is not to be construed as limiting thereof. Although a few embodiments have been described, those skilled in the art will readily appreciate that many modifications are possible in the embodiments without materially departing from the novel teachings and advantages of the inventive concept. Accordingly, all such modifications are intended to be included within the scope of the inventive concept as defined in the claims.

What is claimed is:

1. A system, comprising:
a host device that has a first power mode in which power is consumed at a first rate and a second power mode in which power is consumed at a second rate lower than the first power rate;
a storage device that has a third power mode in which power is consumed at a third rate and a second power mode in which power is consumed at a fourth rate lower than the third rate;
a mode selector that changes host device from the first power mode to the second power mode as a consequence of the host device receiving power from an internal voltage source, and changes the storage device from the third power mode to the fourth power mode as a consequence of the host device changing to the second power mode.

2. The system of claim 1, wherein the host device comprises a computing unit comprising a first core that processes information at a first computing rate and a second core that processes information at a second computing rate, wherein the second computing rate is smaller than the first computing rate, and the first core is idle and the second core is active in the second power mode.

3. The system of claim 2, wherein the host device further comprises a display unit that displays images, wherein the display unit is off in the second power mode.

4. The system of claim 3, wherein the host device further comprises a memory unit used in computations of the computing unit, wherein the memory unit is in a refresh mode in the second power mode.

5. The system of claim 1, wherein the storage device serially interfaces with the host device.

6. The system of claim 5, wherein the storage device is embedded in the host device.

7. The system of claim 5, wherein the host device comprises a first socket, and the storage device comprises a second socket that can be coupled to the first socket, wherein the storage device can be connected to or disconnected from the host device by the first and second sockets.

8. The system of claim 5, wherein the storage device comprises a nonvolatile memory device.

9. The system of claim 1, wherein the storage device comprises a first phase locked loop (PLL), wherein the first PLL is enabled when the storage device is in the third power mode and is disabled when the storage device is in the fourth power mode.

10. The system of claim 9, wherein the host device further comprises a second PLL, wherein the second PLL is enabled when the storage device is in the third power mode and disabled when the storage device is in the fourth power mode.

11. The system of claim 1, wherein an operating speed of the storage device is higher when the storage device is in the third power mode than when the power mode of the storage device is the fourth power mode.

12. The system of claim 11, wherein the internal voltage source comprises a battery installed in the host device.

13. A system, comprising:
first and second storage devices;
a first host device comprising a first computing unit that interfaces with the first storage device; and
a second host device comprising a second computing unit that interfaces with the second storage device,
wherein each of the first and second storage devices has a first power mode in which power is consumed at a first rate and a second power mode in which power is consumed at a second rate smaller than the first rate,
wherein each of the first and second computing units comprises a first core that processes information at a first processing rate and a second core that processes information at a second processing rate, wherein the second processing rate is smaller than the first processing rate, and
wherein when system power for driving the second host device is supplied from a battery installed in the second host device, the first core of the first host device is active, the first core of the second host device is idle, the second core of the second host is active, the first storage device operates in the first power mode, and the second storage device operates in the second power mode.

14. The system of claim 13, wherein the first and second storage devices comprise first and second phase locked loops (PLLs), respectively, wherein when the first PLL of the first storage device is enabled, the second PLL of the second storage device is disabled.

15. The system of claim 13, wherein the first and second host devices further comprise first and second memory units used in computations of the first and second computing units, respectively, wherein when the first memory unit of the first host device is in an operate mode, and the second memory unit of the second host device is in a refresh mode.

16. The system of claim 15, wherein at least one of the first and second memory units comprises a nonvolatile memory device.

17. A method of controlling power consumption in an electronic system comprising a storage device and a host device, comprising:
changing respective power modes of the storage device and the host device between high and low levels in coordination with each other,
wherein changing the respective power modes of the storage device and the host device comprises changing the storage device from a high power mode to a low power mode as a consequence of the host device changing from a high power mode to a low power mode.

18. The method of claim 17, further comprising changing the host device from the high power mode to the low power mode as a consequence of determining that the host device is powered by a battery.

19. The method of claim 17, further comprising changing the host device from the high power mode to the low power mode as a consequence of determining that the host device is not operating a display device.
